(19) United States
(12) Patent Application Publication
(10) Pub. No.: US 2002/0064037 A1
(43) Pub. Date: May 30, 2002

(54) Backlight unit of bi-directional irradiation for liquid crystal display device

(76) Inventor: Pyung Yong Lee, Kyoungki-do (KR)

Correspondence Address: LADAS & PARRY, 224 SOUTH MICHIGAN AVENUE, SUITE 1200, CHICAGO, IL, 60604, US

(21) Appl. No.: 09/994,129

(22) Filed: Nov. 26, 2001

(30) Foreign Application Priority Data
Nov. 25, 2000 (KR) 2000-70703

(51) Int. Cl. G01D 11/28

(52) U.S. Cl. 362/31; 362/26

(57) ABSTRACT

A backlight unit capable of producing a bi-directional surface light while using a single light guide plate without a conventional reflecting plate is disclosed. The backlight unit of bi-directional irradiation, used for upper and lower liquid crystal display (LCD) panels, has at least one fluorescent lamp accommodated in a mold frame to generate light, and at least one lamp reflector surrounding the fluorescent lamp to reflect the light generated from the fluorescent lamp. The backlight unit further has a single light guide plate, which is disposed between the upper and lower LCD panels and near the fluorescent lamp, which has hole patterns formed on a central horizontal plane thereof, and in which the hole patterns produce a bi-directional surface light in upward and downward directions by scattering the light reflected from the lamp reflector. In addition, the backlight unit has upper and lower diffusion plates each disposed between the light guide plate and each LCD panel to uniformalize the bi-directional surface light produced from the light guide plate.

### BACKGROUND OF THE INVENTION

1. Field of the Invention

The present invention relates generally to a backlight unit used for a liquid crystal display (LCD) device. More particularly, the present invention relates to a backlight unit capable of bi-directional irradiation, which can simultaneously irradiate light emitted to a light guide plate to both LCD panels disposed on and under the light guide plate.

2. Description of the Prior Art

As well known in the art, the LCD device is a typical one of electronic display devices. The LCD device is lighter, thinner, smaller and less power consumptive than a cathode ray tube (CRT) widely known and used as another representative display device. Differently from the CRT, the LCD device is not a light-emitting element. An additional light source is therefore required behind an LCD panel so as to form a visual image on a screen of the LCD panel. Currently, a backlight unit employing a fluorescent lamp has been used as the light source for the LCD device.

The conventional backlight unit is exemplarily shown in FIGS. 1 to 3. FIG. 1 is a cross-sectional view showing the conventional backlight unit, FIG. 2 is a perspective view showing two examples of a light guide plate in the conventional backlight unit, and FIG. 3 illustrates the workings of the light guide plate in the conventional backlight unit.

Referring to FIGS. 1 to 3, the conventional backlight unit has two fluorescent lamps 2 formed in the vicinity of both ends of an LCD panel 20 so as to irradiate light to the LCD panel 20. Outer periphery of each fluorescent lamp 2 is surrounded by a lamp reflector 6. The confronting lamp reflectors 6 reflect light irradiated by the fluorescent lamps 2 toward a space therebetween. The light guide plate 4 is dispsoed in the space, closely connected with the fluorescent lamps 2 at both lateral ends thereof, and spaced apart from a backside of the LCD panel 20. The light guide plate 4 uniformly scatters light reflected by the lamp reflectors 6, thus forming a surface light on its entire upper surface facing to the LCD panel 20.

The light guide plate 4 has printed or V-cut patterns 4a formed on its lower surface. Light incident upon the patterns 4a is upwardly reflected and then forms the surface light on the upper surface of the light guide plate 4. The upper surface of the light guide plate 4 is wholly contacted with a diffusion plate 10, while an opposite lower surface of the light guide plate 4 is attached to a reflecting plate 8.

The reflecting plate 8 not only prevents light emitted into the light guide plate 4 from leaking downward, but also reflects light to the upper surface of the light guide plate 4. The diffusion plate 10, which is composed of at least one layer, serves to enhance the uniformity of light incident upon the LCD panel 20.

In addition, inner and outer prism plates 12 and 14 are configured over the diffusion plate 10 so as to change a path of light by 90 degrees and 180 degrees. However, both prism plates 12 and 14 are not necessary to the conventional backlight unit.

Furthermore, a cover plate 16 is disposed over the outer prism plate 14. The cover plate 16 not only protects the outer prism plate 14, in which grooves of triangular or hemispherical shape are formed, from environmental damage, but also enhances the uniformity of light incident upon the LCD panel 20. The above-described elements of the backlight unit are wholly assembled and supported to a mold frame 18.

In the conventional backlight unit, the confronting lamp reflectors 6 reflect light generated from the fluorescent lamps 2. Then the reflected light forms the surface light on the upper surface of the light guide plate 4 by means of the patterns 4a of the light guide plate 4. That is, light emitted into the light guide plate 4 is uniformly scattered by the patterns 4a, while being prevented from leaking downward by the reflecting plate 8. Next the surface light is provided to the LCD panel 20 through the diffusion plate 10 so as to produce a specific image on the screen of the LCD panel 20. That is, the scattered light by the patterns 4a is further uniformalized by the diffusion plate 10, then changes its path while passing through the prism plates 12 and 14, and then perpendicularly strikes the LCD panel 20.

As described above, the conventional backlight unit provides uni-directional irradiation. So, when there is a need for a backlight unit capable of bi-directional irradiation, the conventional technology may adopt two light guide plates and intervening reflecting plate. Such a conventional backlight unit of bi-directional irradiation should, however, meet increases in volume and weight due to the use of two light guide plates and the reflecting plate. Unfortunately, this may reduce the effect of bi-directional irradiation and give rise to a disadvantage over the conventional type of uni-directional irradiation.

### SUMMARY OF THE INVENTION

It is therefore an object of the present invention to provide a backlight unit, which can produce bi-directional surface light while using a single light guide plate without a conventional reflecting plate.

This and other objects in accordance with the present invention are attained by a backlight unit of bi-directional irradiation having a plurality of hole patterns formed in a light guide plate.

The backlight unit according to the present invention, used for upper and lower liquid crystal display (LCD) panels, comprises at least one fluorescent lamp which is accommodated in a mold frame so as to generate light, at least one lamp reflector which surrounds the fluorescent lamp so as to reflect the light generated from the fluorescent lamp, the light guide plate which is disposed between the upper and lower LCD panels and near the fluorescent lamp and which has the plurality of hole patterns formed on a central horizontal plane thereof and in which the hole patterns produce a bi-directional surface light in upward and downward directions by scattering the light reflected from the lamp reflector, and upper and lower diffusion plates each of which is disposed between the light guide plate and each LCD panel so as to uniformalize the bi-directional surface light produced from the light guide plate.

Preferably, the hole patterns of the light guide plate may be spaced apart from each other and arranged lengthwise and breadthwise over the central horizontal plane in the light guide plate. Each of the hole patterns may have a cross-section of circular or polygonal form. Furthermore, the hole patterns may have cross-sections of different diameters or may be distributed with different densities.

The backlight unit according to the present invention may further comprise upper and lower prism plates each of which is disposed between each diffusion plate and each LCD panel, and upper and lower cover plates each of which is disposed between each prism plate and each LCD panel.

### BRIEF DESCRIPTION OF THE DRAWINGS

FIG. 1 is a cross-sectional view showing a conventional backlight unit.

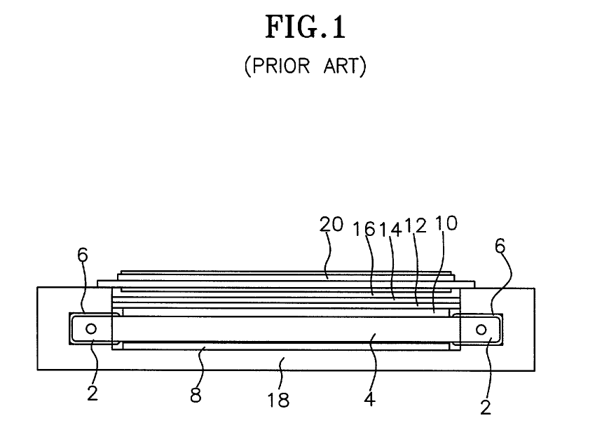

FIG. 2 is a perspective view showing two examples of a light guide plate in a conventional backlight unit.

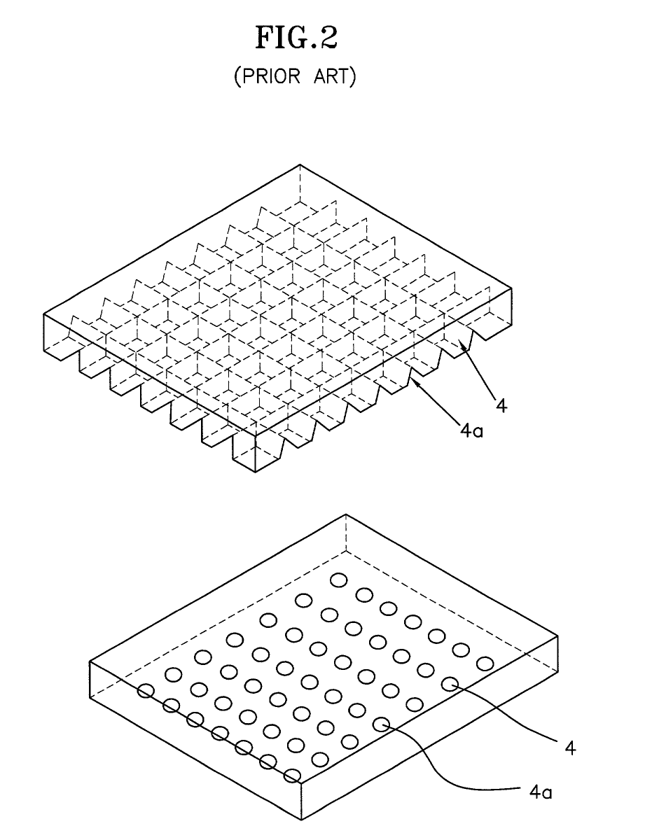

FIG. 3 illustrates the workings of a light guide plate in a conventional backlight unit.

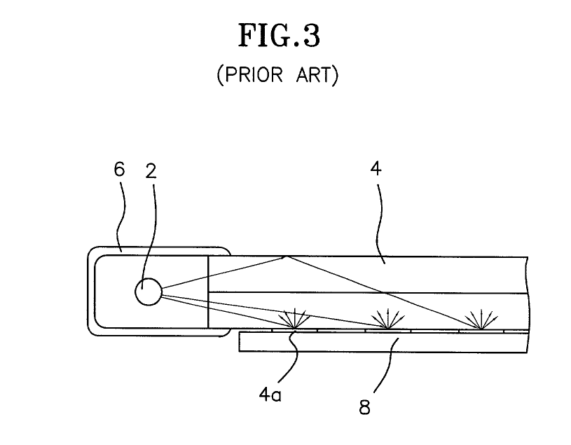

FIG. 4 is a cross-sectional view showing a backlight unit of bi-directional irradiation according to an embodiment of the present invention.

FIG. 5 is a perspective view showing a light guide plate in a backlight unit of bi-directional irradiation according to an embodiment of the present invention.

FIG. 6 illustrates the workings of a light guide plate in a backlight unit of bi-directional irradiation according to an embodiment of the present invention.

FIG. 7 illustrates two examples of hole patterns of a light guide plate in a backlight unit of bi-directional irradiation according to an embodiment of the present invention.

### DETAILED DESCRIPTION OF THE INVENTION

The present invention will be now described more fully hereinafter with reference to accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

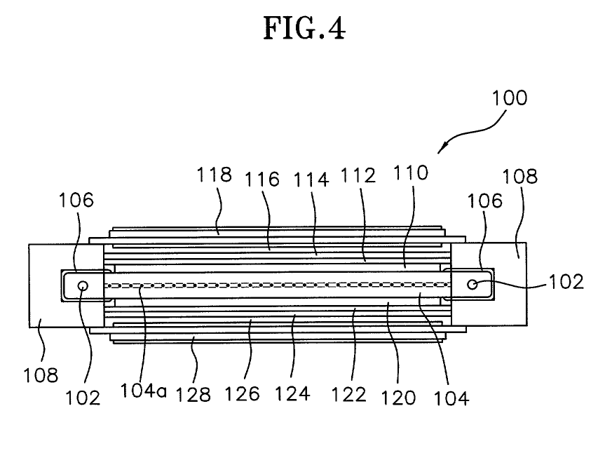

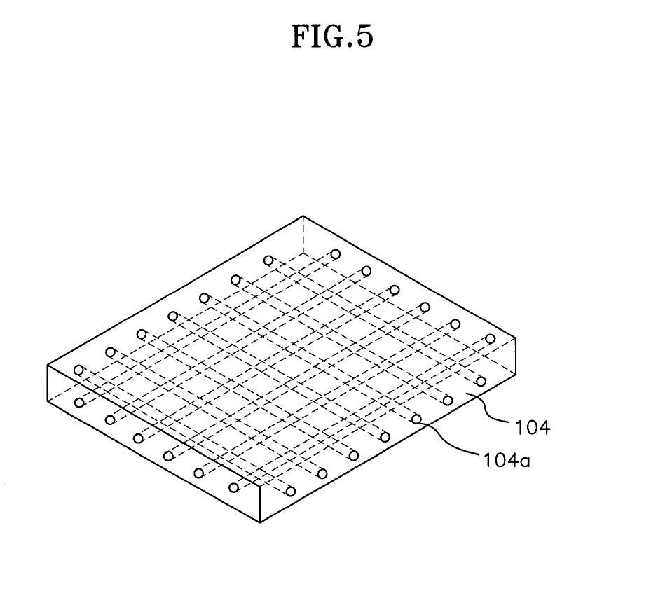

FIG. 4 is a cross-sectional view showing a backlight unit of bi-directional irradiation according to an embodiment of the present invention, and FIG. 5 is a perspective view showing a light guide plate in a backlight unit of bi-directional irradiation according to an embodiment of the present invention.

Referring to FIGS. 4 and 5, the backlight unit 100 is configured to provide simultaneous bi-directional irradiation to upper and lower LCD panels 118 and 128, while employing a single light guide plate 104. The light guide plate 104 is disposed between the LCD panels 118 and 128 so as to simultaneously emit light to the LCD panels 118 and 128. The simultaneous emission of light is made possible by a plurality of hole patterns 114a of the light guide plate 104. The hole patterns 114a are formed on a central horizontal plane, which imaginarily or substantially divides the light guide plate 104 into upper and lower parts. In addition, the hole patterns 114a are spaced apart from each other and arranged lengthwise and breadthwise over the central horizontal plane.

The backlight unit 100 has at least one, preferably two, fluorescent lamp 102 formed contiguously to at least one, preferably both, lateral end of the light guide plate 104. A lamp reflector 106 surrounds the fluorescent lamp 102. The lamp reflector 106 reflects light irradiated by the fluorescent lamp 102 toward the light guide plate 104.

On and under the light guide plate 104, upper and lower diffusion plates 110 and 120 are disposed respectively. Each diffusion plate 110 or 120, which is composed of at least one layer, serves to enhance the uniformity of light incident upon the LCD panel 118 or 128.

Additionally, upper and lower inner prism plates 112 and 122 are formed respectively on external surfaces of the diffusion plates 110 and 120, and upper and lower outer prism plates 114 and 124 are also formed thereto. The prism plates 112, 114, 122 and 124 serve to change a path of light by 90 degrees and 180 degrees. If necessary, inner or outer prism plate only may be used. Alternatively, if possible, no prism plate may be used.

Furthermore, upper and lower cover plates 116 and 126 are disposed respectively over the outer prism plates 114 and 124. The cover plates 116 and 126 protect the outer prism plates 114 and 124, each of which has grooves of triangular or hemispherical shape. Also, the cover plates 116 and 126 serve to enhance the uniformity of light incident upon the LCD panels 118 and 128.

As described above, the diffusion plates 110 and 120, the inner prism plates 112 and 122, the outer prism plates 114 and 124, and the cover plates 116 and 126 are sequentially stacked on and under the single light guide plate 104, while corresponding plates being symmetric with respect to the light guide plate 104. These plates are wholly assembled and supported to a mold frame 108.

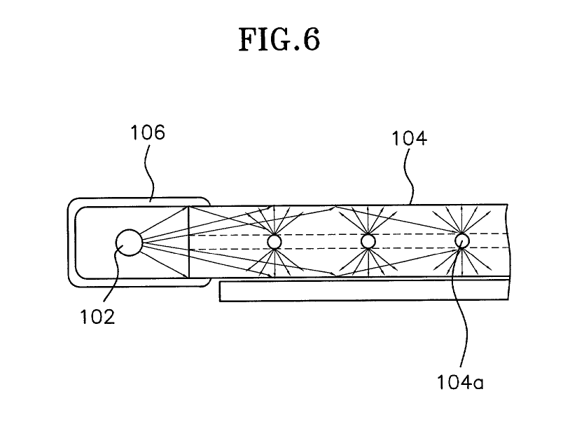

FIG. 6 illustrates the workings of the light guide plate 104. As shown in FIG. 6, when the fluorescent lamp 102 generates light, the generated light is reflected by the lamp reflector 106 and then enters the light guide plate 104. Subsequently, the incident light is uniformly scattered by the hole patterns 104a in the light guide plate 104, so that the scattered light produces bi-directional surface light in upward and downward directions on upper and lower surfaces of the light guide plate 104.

Returning to FIG. 4, the bi-directional surface light emitted from the upper and lower surfaces of the light guide plate 104 is further uniformalized by the diffusion plates 110 and 120, and then changes its path while passing through the prism plates 112, 114, 122 and 124. Next the light with changed path penetrates the cover plates 116 and 126, and then perpendicularly strikes the LCD panels 118 and 128 so as to produce a specific image on the screen of each LCD panel 118 or 128.

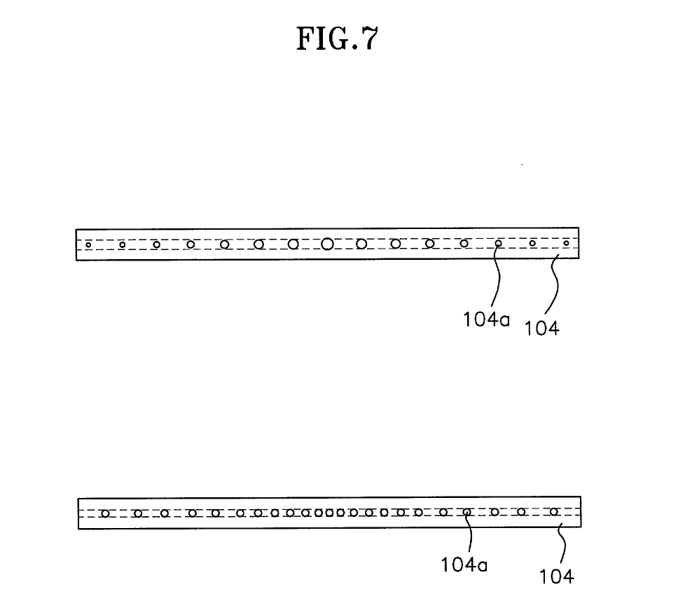

FIG. 7 illustrates two examples of the hole patterns 104a of the light guide plate 104. As exemplarily depicted in FIG. 7, the hole patterns 104a can have cross-sections of different diameters. Furthermore, the hole patterns 104a can be distributed with different densities. That is, the adjacent hole patterns 104a can have different intervals. The hole patterns 104a can be formed by utilizing mechanical, laser or hydraulic force. And, each hole pattern 104a has a cross-section of circular or polygonal form.

By variously forming the hole patterns 104a as described above, the uniformity in the backlight unit can be adjusted, and the strength of light can be differently regulated in upward and downward directions.

As fully described hereinbefore, the backlight unit of bi-directional irradiation according to the present invention has several advantages. For example, since the present invention uses the only single light guide plate and no conventional reflecting plate to realize bi-directional irradiation, the backlight unit of the present invention becomes simpler, thinner and more economical.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A backlight unit of bi-directional irradiation used for upper and lower liquid crystal display (LCD) panels, comprising:
at least one fluorescent lamp accommodated in a mold frame so as to generate light;
at least one lamp reflector surrounding said fluorescent lamp so as to reflect the light generated from said fluorescent lamp;
a light guide plate disposed between the upper and lower LCD panels and near said fluorescent lamp, and having a plurality of hole patterns formed on a central horizontal plane thereof, wherein the hole patterns produce a bi-directional surface light in upward and downward directions by scattering the light reflected from said lamp reflector; and
upper and lower diffusion plates each disposed between said light guide plate and each LCD panel so as to uniformalize the bi-directional surface light produced from said light guide plate.

2. The backlight unit of claim 1, wherein the hole patterns of said light guide plate are spaced apart from each other and arranged lengthwise and breadthwise over the central horizontal plane in said light guide plate.

3. The backlight unit of claim 2, wherein each hole pattern has a cross-section of circular or polygonal form.

4. The backlight unit of claim 2, wherein the hole patterns have cross-sections of different diameters.

5. The backlight unit of claim 2, wherein the hole patterns are distributed with different densities.

6. The backlight unit of claim 1, further comprising:
upper and lower prism plates each disposed between each diffusion plate and each LCD panel.

7. The backlight unit of claim 6, further comprising:
upper and lower cover plates each disposed between each prism plate and each LCD panel.
